(19) United States
(12) Patent Application Publication
(10) Pub. No.: US 2025/0264654 A1
(43) Pub. Date: Aug. 21, 2025

(54) BACKLIGHT AND DISPLAY DEVICE

(71) Applicant: Japan Display Inc., Tokyo (JP)

(72) Inventors: Takashi OTA, Tokyo (JP); Masafumi OKADA, Tokyo (JP); Nobuyuki SUZUKI, Tokyo (JP); Takaaki WATANABE, Tokyo (JP)

(21) Appl. No.: 19/044,848

(22) Filed: Feb. 4, 2025

(30) Foreign Application Priority Data
Feb. 16, 2024 (JP) 2024-021936

(51) Int. Cl. F21V 8/00

(52) U.S. Cl. CPC G02B 6/0053; G02B 6/0038

(57) ABSTRACT

A backlight includes: a first prism sheet including a first prism surface on a side opposite to the flat surface, the first prism surface including first grooves, the first grooves being adjacent in a first direction and extending in a second direction; and a second prism sheet including a second prism surface directly facing the first prism surface, the second prism sheet including a flat surface on a side opposite to the second prism surface, the second prism surface including second grooves, the second grooves being adjacent in the first direction and extending in the second direction. In light distribution characteristics on a first vertical plane spreading in the first direction and a vertical direction that is perpendicular to both the first direction and the second direction, peaks of luminous intensity are observed in two directions excluding the vertical direction.

### CROSS-REFERENCE TO RELATED APPLICATION

The present application claims priority from Japanese patent application JP2024-021936 filed on Feb. 16, 2024, the contents of which are hereby incorporated by reference into this application.

### BACKGROUND

### 1. Field

This disclosure relates to a backlight and a display device.

### 2. Description of the Related Art

A display capable of separating light to the left and right to present different images in two directions is known (JP2008-538154A). To enable such a display, a backlight with a light distribution characteristic featuring luminance peaks in two directions is required.

In edge-lit backlights, where light enters through the end face of a light guide plate, further improvements in luminance are anticipated.

### SUMMARY

This disclosure aims to improve luminance in two directions.

A backlight includes: a light source; a light guide plate including an end face that serves as an incident surface of light from the light source, and a plate surface that serves as an emission surface of the light; a first prism sheet overlapping with the light guide plate, the first prism sheet including a flat surface directly facing the plate surface, the first prism sheet including a first prism surface on a side opposite to the flat surface, the first prism surface including first grooves, the first grooves being adjacent in a first direction and extending in a second direction, the first direction and the second direction being perpendicular; and a second prism sheet overlapping with the first prism sheet, the second prism sheet including a second prism surface directly facing the first prism surface, the second prism sheet including a flat surface on a side opposite to the second prism surface, the second prism surface including second grooves, the second grooves being adjacent in the first direction and extending in the second direction, wherein, in light distribution characteristics on a first vertical plane spreading in the first direction and a vertical direction that is perpendicular to both the first direction and the second direction, peaks of luminous intensity are observed in two directions excluding the vertical direction.

A display device includes: the backlight, and a display panel in an arrangement that enables incidence of the light emitted from the backlight into a rear.

### BRIEF DESCRIPTION OF THE DRAWINGS

FIG. 1 is a plan view of a backlight according to an embodiment.

FIG. 2 is a sectional view taken along line II-II of the backlight in FIG. 1.

FIG. 3 is an enlarged partial view of a first prism sheet and a second prism sheet.

FIG. 4 is a sectional view taken along line IV-IV of the backlight in FIG. 1.

FIG. 5 is a light distribution characteristic diagram of the backlight according to the embodiment.

FIG. 6 is a sectional view of a backlight according to related art.

FIG. 7 is a light distribution characteristic diagram of light emitted from a light guide plate in related art.

FIG. 8 is a light distribution characteristic diagram of light emitted from a diffusion sheet in related art.

FIG. 9 is a schematic diagram of a display device according to the embodiment.

### DETAILED DESCRIPTION

Hereinafter, some embodiments will be described with reference to the drawings. Here, the invention can be embodied according to various aspects within the scope of the invention without departing from the gist of the invention and is not construed as being limited to the content described in the embodiments exemplified below.

The drawings are further schematically illustrated in widths, thickness, shapes, and the like of units than actual forms to further clarify description in some cases but are merely examples and do not limit interpretation of the invention. In the present specification and the drawings, the same reference numerals are given to elements having the same functions described in the previously described drawings, and the repeated description will be omitted.

Further, in the detailed description, “on” or “under” in definition of positional relations of certain constituents, and other constituents includes not only a case in which a constituent is located just on or just under a certain constituent but also a case in which another constituent is interposed between constituents unless otherwise mentioned.

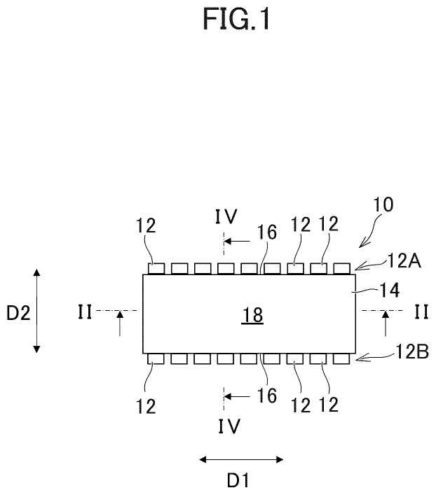

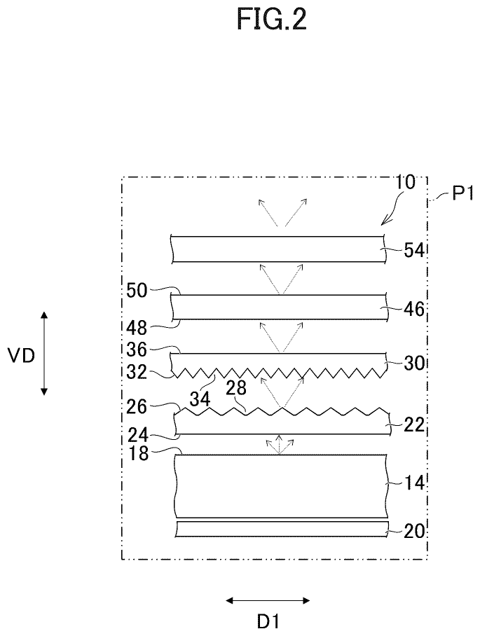

FIG. 1 is a plan view of a backlight according to an embodiment. FIG. 2 is a sectional view taken along line II-II of the backlight in FIG. 1. A backlight 10 includes a light source 12 (e.g., laser). The light source 12 includes a pair of light sources 12. The light source 12 is configured to emit light. A first group of light sources 12A are arranged in a first direction D1, and a second group of light sources 12B are arranged in the first direction D1. There is a gap in a second direction D2, which is perpendicular to the first direction D1, between the first group of light sources 12A and the second group of light sources 12B.

The backlight 10 includes a light guide plate 14. The light guide plate 14 includes an end face 16 that serves as an incident surface of light from the light source 12. The backlight 10 employs an edge-lit (side-lit) configuration. The light source 12 is adjacent to the light guide plate 14 in the second direction D2. A pair of light sources 12 are adjacent to both sides of the light guide plate 14 in the second direction D2. This configuration allows light to enter from opposite directions, thereby reducing luminance unevenness caused by differences in distance from the light source 12. The light guide plate 14 includes a plate surface 18 that serves as an emission surface of light. On the side opposite to the plate surface 18, a reflective sheet 20 is provided to direct light toward the emission surface.

The backlight 10 includes a first prism sheet 22. The first prism sheet 22 overlaps with the light guide plate 14. The first prism sheet 22 includes a flat surface 24 directly facing the plate surface 18. No diffusion sheet is interposed between the first prism sheet 22 and the light guide plate 14.

The first prism sheet 22 includes a first prism surface 26 on the side opposite to the flat surface 24. The first prism surface 26 includes first grooves 28. The first grooves 28 are adjacent in the first direction D1 and extend in the second direction D2. Each first groove 28 is a V-groove.

The backlight 10 includes a second prism sheet 30. The second prism sheet 30 overlaps with the first prism sheet 22. The second prism sheet 30 includes a second prism surface 32 directly facing the first prism surface 26. The second prism surface 32 includes second grooves 34. The second grooves 34 are adjacent in the first direction D1 and extend in the second direction D2. Each second groove 34 is a V-groove. The second prism sheet 30 includes a flat surface 36 on the side opposite to the second prism surface 32.

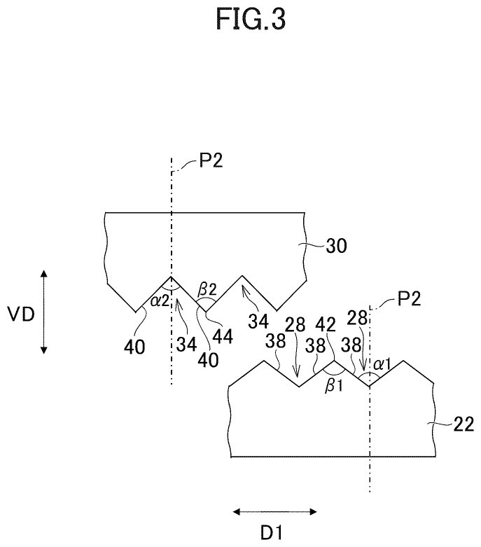

FIG. 3 is an enlarged partial view of the first prism sheet 22 and the second prism sheet 30. Each first groove 28 includes a pair of first inclined surfaces 38. The pair of first inclined surfaces 38 are of plane-symmetry. The reference plane of the plane-symmetry is a second vertical plane P2 spreading in the vertical direction VD and the second direction D2. Each second groove 34 includes a pair of second inclined surfaces 40. The pair of second inclined surfaces 40 are of plane-symmetry. The reference plane of the plane symmetry is the second vertical plane P2 spreading in the vertical direction VD and the second direction D2.

A first external angle α1 (e.g., 120 degrees) between the pair of first inclined surfaces 38 is equal to or greater than a second external angle α2 (e.g., 90 degrees) between the pair of second inclined surfaces 40. The difference between the first external angle α1 and the second external angle α2 is at least 20 degrees and at most 40 degrees.

The first prism surface 26 includes a first ridge portion 42 between an adjacent pair of the first grooves 28. The first internal angle β1 of the first ridge portion 42 is equal to the first external angle α1. The second prism surface 32 includes a second ridge portion 44 between an adjacent pair of the second grooves 34. The second internal angle β2 of the second ridge portion 44 is equal to the second external angle α2.

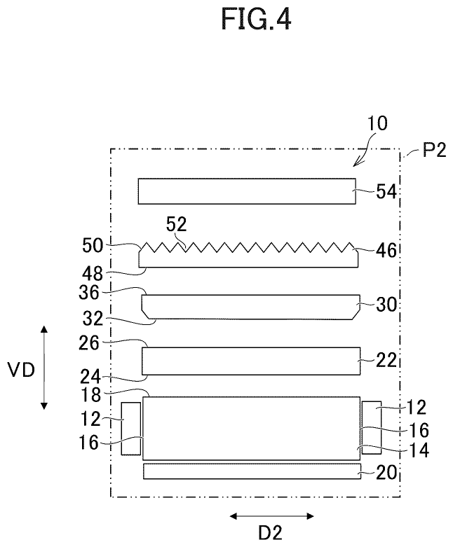

FIG. 4 is a sectional view taken along line IV-IV of the backlight 10 in FIG. 1. The backlight 10 includes a third prism sheet 46. The third prism sheet 46 includes a bottom surface 48 directly facing the flat surface 36 of the second prism sheet 30. The third prism sheet 46 includes a third prism surface 50 on the side opposite to the bottom surface 48. The third prism surface 50 includes third grooves 52. The third grooves 52 extend in the first direction D1 and are adjacent in the second direction D2. The backlight 10 includes a dual brightness enhancement film 54 directly facing the third prism surface 50 of the third prism sheet 46.

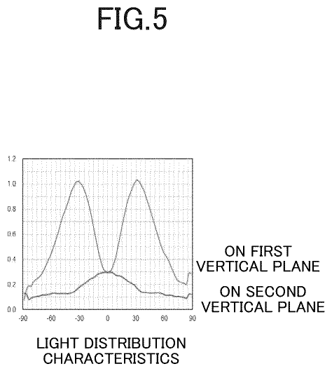

FIG. 5 is a light distribution characteristic diagram of the backlight 10 according to the embodiment. In the light distribution characteristics on the first vertical plane P1 spreading in the vertical direction VD and the first direction D1 as shown in FIG. 2, peaks of luminous intensity are observed in two directions excluding the vertical direction VD. The angle in the vertical direction VD is 0 degrees. The angles in the two directions are +30 degrees or more and −30 degrees or less.

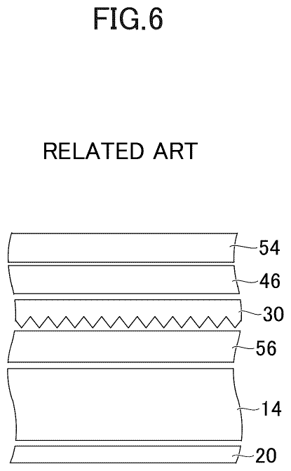

FIG. 6 is a sectional view of a backlight according to related art. The first prism sheet 22 of the embodiment is replaced with a diffusion sheet 56. The other components are the same as those of the embodiment. When the second external angle α2 of the second prism sheet 30 is set to 90 degrees, the backlight of related art achieves the highest luminous intensity peak.

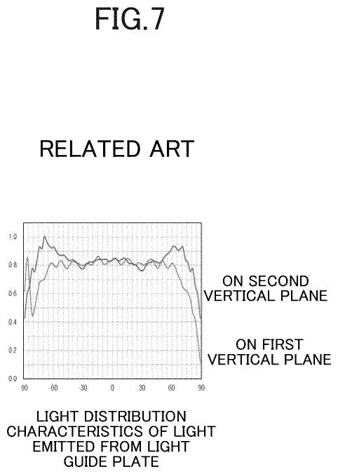

FIG. 7 is a light distribution characteristic diagram of light emitted from the light guide plate 14 in related art. The luminous intensity of light emitted from the light guide plate 14 is uniform over a range of ±30 degrees or more.

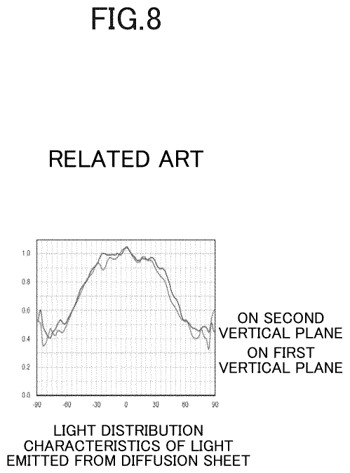

FIG. 8 is a light distribution characteristic diagram of light emitted from a diffusion sheet 56 in related art. The luminous intensity of light emitted from the diffusion sheet 56 is highest near 0 degrees.

In contrast, the backlight 10 according to the embodiment, which uses the first prism sheet 22 instead of the diffusion sheet 56, achieves peaks of luminous intensity in two directions, as shown in FIG. 5, improving luminance in the two directions. In a simulation with the first external angle α1 set to 120 degrees and the second external angle α2 set to 90 degrees, the luminous intensity of the embodiment was 1.03 when the luminous intensity was 1.0 in related art. In another simulation with both the first external angle α1 and the second external angle α2 set to 90 degrees, the luminous intensity of the embodiment was 1.02.

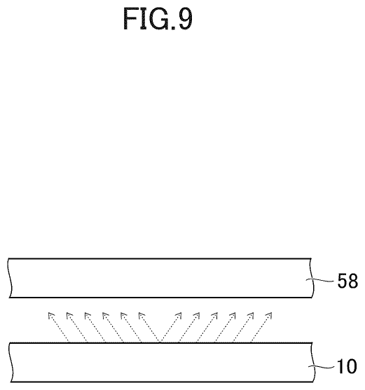

FIG. 9 is a schematic diagram of a display device according to the embodiment. The display device includes the backlight 10. The display device includes a display panel 58 (e.g., liquid crystal display panel) in an arrangement that enables incidence of the light emitted from the backlight 10 into a rear.

### [Outline of the Embodiment]

(1) A backlight 10 including: a light source 12; a light guide plate 14 including an end face 16 that serves as an incident surface of light from the light source 12, and a plate surface 18 that serves as an emission surface of the light; a first prism sheet 22 overlapping with the light guide plate 14, the first prism sheet 22 including a flat surface 24 directly facing the plate surface 18, the first prism sheet 22 including a first prism surface 26 on a side opposite to the flat surface 24, the first prism surface 26 including first grooves 28, the first grooves 28 being adjacent in a first direction D1 and extending in a second direction D2, the first direction D1 and the second direction D2 being perpendicular; and a second prism sheet 30 overlapping with the first prism sheet 22, the second prism sheet 30 including a second prism surface 32 directly facing the first prism surface 26, the second prism sheet 30 including a flat surface 36 on a side opposite to the second prism surface 32, the second prism surface 32 including second grooves 34, the second grooves 34 being adjacent in the first direction D1 and extending in the second direction D2, wherein, in light distribution characteristics on a first vertical plane P1 spreading in the first direction D1 and a vertical direction VD that is perpendicular to both the first direction D1 and the second direction D2, peaks of luminous intensity are observed in two directions excluding the vertical direction VD.

The first prism surface 26 reduces light in the vertical direction VD and improves luminance in the two directions.

(2) The backlight 10 according to (1), wherein each of the first grooves 28 and the second grooves 34 is a V-groove.

(3) The backlight 10 according to (1), wherein each of the first grooves 28 includes a pair of first inclined surfaces 38, and each of the second grooves 34 includes a pair of second inclined surfaces 40.

(4) The backlight 10 according to (3), wherein the pair of first inclined surfaces 38 are of plane-symmetry, the pair of second inclined surfaces 40 are of plane-symmetry, and a reference plane of the plane-symmetry is a second vertical plane P2 spreading in the vertical direction VD and the second direction D2.

(5) The backlight 10 according to (3), wherein a first external angle α1 between the pair of first inclined surfaces 38 is equal to or greater than a second external angle α2 between the pair of second inclined surfaces 40.

(6) The backlight 10 according to (5), wherein the first external angle α1 and the second external angle α2 differ by at least 20 degrees and at most 40 degrees.

(7) The backlight 10 according to (1), wherein the light source 12 is adjacent to the light guide plate 14 in the second direction D2.

(8) The backlight 10 according to (7), wherein the light source 12 includes a pair of light sources 12, and the pair of light sources 12 are adjacent to both sides of the light guide plate 14 in the second direction D2.

(9) The backlight 10 according to (1), further including a third prism sheet 46, the third prism sheet 46 including a bottom surface 48 directly facing the flat surface 36 of the second prism sheet 30, the third prism sheet 46 including a third prism surface 50 on a side opposite to the bottom surface 48, the third prism surface 50 including third grooves 52, the third grooves 52 extending in the first direction D1 and being adjacent in the second direction D2.

(10) The backlight 10 according to (9), further comprising a dual brightness enhancement film 54 directly facing the third prism surface 50 of the third prism sheet 46.

(11) The backlight 10 according to (1), wherein an angle in the vertical direction VD is 0 degrees, and angles in the two directions are an angle of +30 degrees or more and an angle of −30 degrees or less.

(12) A display device comprising: the backlight 10 according to any one of (1) to (11), and a display panel 58 in an arrangement that enables incidence of the light emitted from the backlight 10 into a rear.

The embodiments described above are not limited and different variations are possible. The structures explained in the embodiments may be replaced with substantially the same structures and other structures that can achieve the same effect or the same objective.

What is claimed is:

1. A backlight comprising:
a light source;
a light guide plate including an end face that serves as an incident surface of light from the light source, and a plate surface that serves as an emission surface of the light;
a first prism sheet overlapping with the light guide plate, the first prism sheet including a flat surface directly facing the plate surface, the first prism sheet including a first prism surface on a side opposite to the flat surface, the first prism surface including first grooves, the first grooves being adjacent in a first direction and extending in a second direction, the first direction and the second direction being perpendicular; and
a second prism sheet overlapping with the first prism sheet, the second prism sheet including a second prism surface directly facing the first prism surface, the second prism sheet including a flat surface on a side opposite to the second prism surface, the second prism surface including second grooves, the second grooves being adjacent in the first direction and extending in the second direction,
wherein, in light distribution characteristics on a first vertical plane spreading in the first direction and a vertical direction that is perpendicular to both the first direction and the second direction, peaks of luminous intensity are observed in two directions excluding the vertical direction.

2. The backlight according to claim 1, wherein each of the first grooves and the second grooves is a V-groove.

3. The backlight according to claim 1, wherein
each of the first grooves includes a pair of first inclined surfaces, and
each of the second grooves includes a pair of second inclined surfaces.

4. The backlight according to claim 3, wherein
the pair of first inclined surfaces are of plane-symmetry,
the pair of second inclined surfaces are of plane-symmetry, and
a reference plane of the plane-symmetry is a second vertical plane spreading in the vertical direction and the second direction.

5. The backlight according to claim 3, wherein a first external angle between the pair of first inclined surfaces is equal to or greater than a second external angle between the pair of second inclined surfaces.

6. The backlight according to claim 5, wherein the first external angle and the second external angle differ by at least 20 degrees and at most 40 degrees.

7. The backlight according to claim 1, wherein the light source is adjacent to the light guide plate in the second direction.

8. The backlight according to claim 7, wherein the light source includes a pair of light sources, and
the pair of light sources are adjacent to both sides of the light guide plate in the second direction.

9. The backlight according to claim 1, further comprising a third prism sheet,
the third prism sheet including a bottom surface directly facing the flat surface of the second prism sheet,
the third prism sheet including a third prism surface on a side opposite to the bottom surface,
the third prism surface including third grooves,
the third grooves extending in the first direction and being adjacent in the second direction.

10. The backlight according to claim 9, further comprising a dual brightness enhancement film directly facing the third prism surface of the third prism sheet.

11. The backlight according to claim 1, wherein
an angle in the vertical direction is 0 degrees, and
angles in the two directions are an angle of +30 degrees or more and an angle of −30 degrees or less.

12. A display device comprising:
the backlight according to claim 1, and
a display panel in an arrangement that enables incidence of the light emitted from the backlight into a rear.
